(19) United States
(12) Patent Application Publication
(10) Pub. No.: US 2019/0114946 A1
(43) Pub. Date: Apr. 18, 2019

(54) Anti-Tamper Band and Method of Use

(71) Applicants: Anthony Holyoak, Columbia, MD (US); Troy G. Phelps, Las Vegas, NV (US)

(72) Inventors: Anthony Holyoak, Columbia, MD (US); Troy G. Phelps, Las Vegas, NV (US)

(21) Appl. No.: 16/157,493

(22) Filed: Oct. 11, 2018

Related U.S. Application Data
(60) Provisional application No. 62/571,280, filed on Oct. 12, 2017.

(51) Int. Cl. G09F 3/00; B65D 55/06; G09F 3/10

(52) U.S. Cl. CPC G09F 3/0292; B65D 55/06; G09F 2003/0272; B65D 2101/0007; G09F 3/10

(57) ABSTRACT

An anti-tamper band. The anti-tamper band includes a flexible member having a central portion with a pair of elongated arms extending therefrom. An adhesive is disposed across a lower surface of the flexible member, such that the flexible member is securable to a container. A line of perforation extends across a width of each of the pair of elongated arms, such that a user can inspect the line of perforation for signs of tampering and easily tear across the line of perforation to open the container.

### CROSS REFERENCE TO RELATED APPLICATIONS

This application claims the benefit of U.S. Provisional Application No. 62/571,280 filed on Oct. 12, 2017. The above identified patent application is herein incorporated by reference in its entirety to provide continuity of disclosure.

### BACKGROUND OF THE INVENTION

The present invention relates to an anti-tamper band. Specifically, the present invention relates to an anti-tamper band with a line of perforation, wherein the line of perforation allows a user to visually inspect the anti-tamper band for signs of damage to indicate signs of tampering.

Many people enjoy eating in restaurants or ordering food from various delivery establishments. Once the food is prepared and placed in the delivery container, the delivery driver is tasked with delivering the food to the user. However, there is no way for a user to determine whether their food has been tampered with between being placed in the delivery container and being received by the user. Tampering with a food delivery can result in food being stolen or otherwise contaminated, which can lead to illness.

Typically, a delivery container is secured in a closed position via tying a knot in the delivery bag or placing a sticker over the opening of the container. However, the delivery driver can very easily untie or remove the sticker to taste or steal food within the container, and then re-secure the container afterwards. Therefore, a device that ensures a customer's food delivery has not been tampered with, or alternatively, one that clearly indicates whether the food delivery has been tampered with is desired.

In light of the devices disclosed in the known art, it is submitted that the present invention substantially diverges in design elements from the known art and consequently it is clear that there is a need in the art for an improvement to existing anti-tamper bands. In this regard, the instant invention substantially fulfills these needs.

### SUMMARY OF THE INVENTION

In view of the foregoing disadvantages inherent in the known types of anti-tamper bands now present in the known art, the present invention provides an anti-tamper band wherein the same can be utilized for providing convenience for the user when visually inspecting a container for signs of tampering.

The present system comprises a flexible member having a central portion and a pair of elongated arms extending from opposing ends of the central portion. An adhesive is disposed on a lower surface of the flexible member, the adhesive configured to removably secure the flexible member to a container. A line of perforation extends across a width of each of the pair of elongated arms, wherein the line of perforation is configured to easily tear the elongated arm therealong. In some embodiments, the central member comprises a circular shape having a diameter greater than the width of the pair of elongated arms. In another embodiment, a protective cover is removably secured to the lower surface, wherein the protective cover is configured to preserve the adhesive properties of the adhesive. In other embodiments, the protective cover comprises a tab extending therefrom, wherein the tab extends beyond a perimeter of the flexible member. In yet another embodiment, indicia is disposed on an upper surface of the flexible member, wherein the indicia is configured to indicate the time of application of the flexible member. In some embodiments, the adhesive is configured to permanently affix to a container. In another embodiment, a second line of perforation extends across a diameter of the central portion. In other embodiments, a third line of perforation extends across the central member and intersects the second line of perforation perpendicularly. In yet another embodiment, the adhesive is disposed along the lower surface between each line of perforation and a distal end of each of the pair of elongated arms. In some embodiments, the adhesive is disposed along the lower surface of the central portion.

The method of using the present system comprises applying a flexible member having a central portion and a pair of elongated arms extending therefrom to a container, wherein a lower surface of the flexible member comprises an adhesive thereon, and wherein each of the elongated arms are disposed on the container on opposing sides of an opening of the container. The user then inspects a line of perforation extending along a width of each of the pair of elongated arms for damage, tearing along the line of perforation to remove the flexible member from the container, and opening the container. In some embodiments, the method further comprises removing a protective cover extending along a lower surface of the flexible member. In another embodiment, the method further comprises recording a time of application on an upper surface of the flexible member as indicated by an indicia thereon. In other embodiments, the method further comprises inspecting the container for damage caused by removal of the adhesive.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the anti-tamper band.

FIG. 2 shows a perspective view of a protective cover of an embodiment of the anti-tamper band.

FIG. 3 shows a perspective view of an embodiment of the anti-tamper band in use.

### DETAILED DESCRIPTION OF THE INVENTION

Reference is made herein to the attached drawings. Like reference numerals are used throughout the drawings to depict like or similar elements of the anti-tamper band. The figures are intended for representative purposes only and should not be considered to be limiting in any respect.

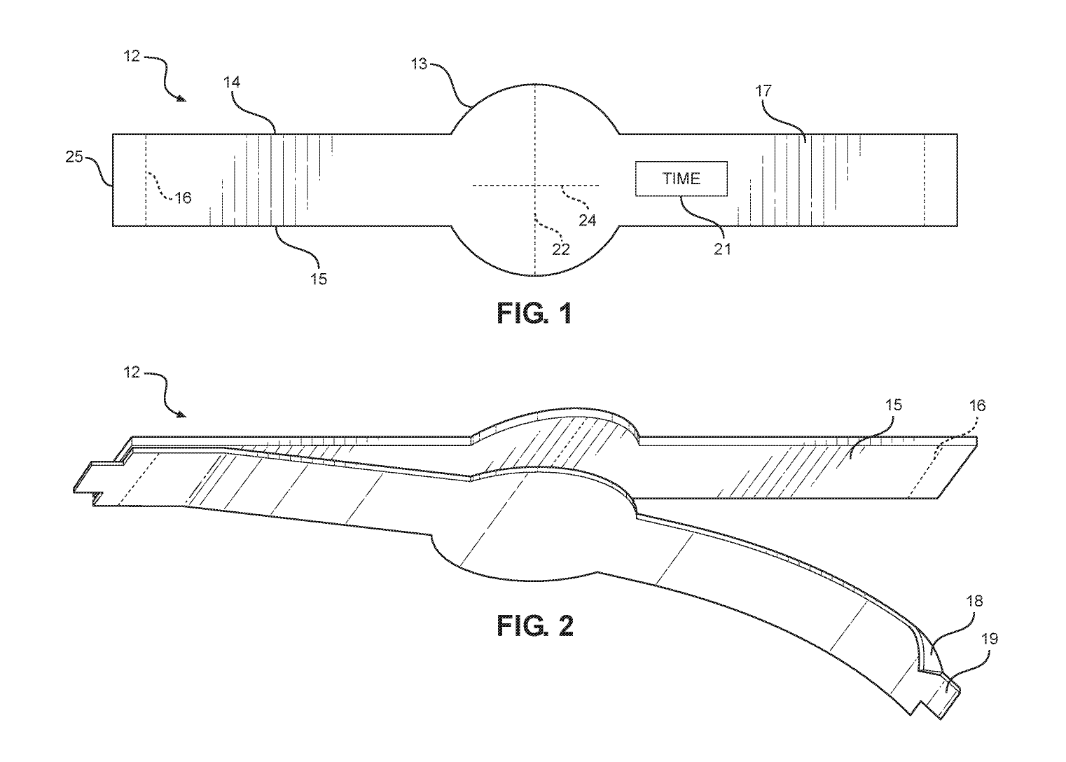

Referring now to FIG. 1, there is shown a perspective view of an embodiment of the anti-tamper band. The anti-tamper band comprises a flexible member 12 having a central portion 13 with a pair of elongated arms 14 extending therefrom. In the illustrated embodiment, the pair of elongated arms 14 extend from opposing sides of the central portion 13 such that the pair of elongated arms 14 extend along a same longitudinal axis, however, in alternate embodiments, the pair of elongated arms 14 can extend in various orientations as desired by the user for use with various food containers. For example, in one such alternate embodiment, two pairs of elongated arms 14 can extend from the central portion 13, wherein the pairs of elongated arms 14 are perpendicular to each other, thereby forming an X-shape. In the shown embodiment, the central portion 13 comprises a diameter greater than a width of each of the pair of elongated arms 14, such that the central portion 13 comprises a larger surface area to adhere to a food container. In the illustrated embodiment, the flexible member 12 further comprises indicia 21 disposed on an upper surface 17 thereof. The indicia 21 can indicate a location to log a time of packaging or delivery of the food container, such that a user be informed of how long the food container was in transit. Alternatively, the indicia 21 can indicate a logo or other trade dress representative of the restaurant or company utilizing the anti-tamper band. In the illustrated embodiment, the indicia 21 is disposed on one of the pair of elongated arms 14, however in alternate embodiments, the indicia 21 can be located anywhere along the flexible member 12, such as the central portion 13.

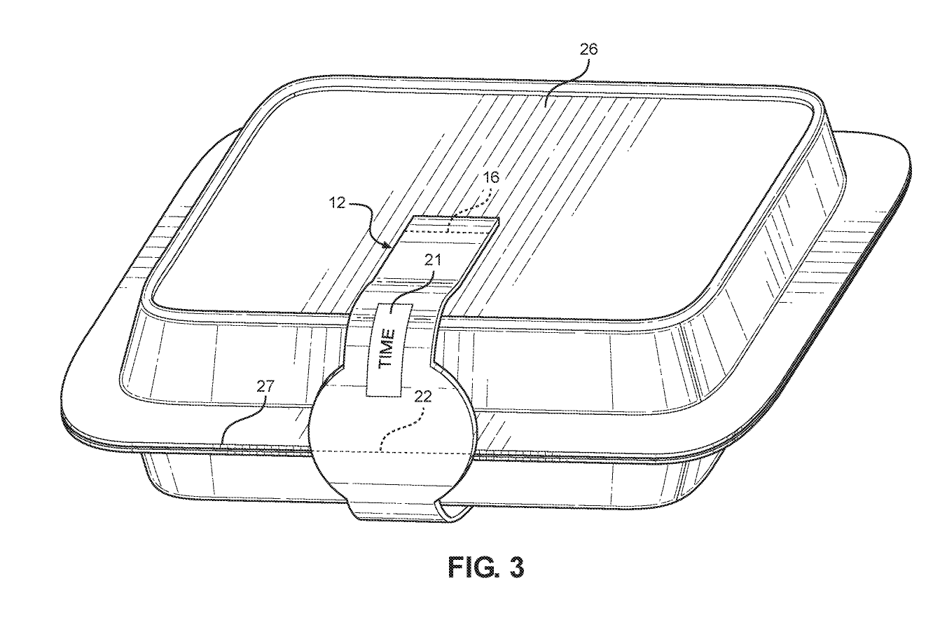

The flexible member 12 further comprises an adhesive disposed across a lower surface 15 thereof. In some embodiments, the adhesive extends along an entire lower surface 15 of the flexible member 12, while in alternate embodiments, the lower surface 15 along the pair of elongated arms 14 comprise no adhesive thereon. In this way, the user can easily remove the flexible member 12 from a food container (shown in FIG. 3, 26), thereby allowing the user to open the food container. Greater surface area of coverage for the adhesive provides stronger adhesion to the food container, thereby minimizing the risk of tampering without leaving appreciable evidence thereon. In some embodiments, the adhesive comprises a pressure-sensitive adhesive of sufficient strength to visibly damage a food container when the adhesive is removed therefrom, such that additional visual evidence of potential tampering is provided. In some embodiments, the adhesive is disposed on the lower surface 15 of the central portion 13 and between a distal end 25 of each of the pair of elongated arms 14 and a line of perforation 16 disposed on each of the pair of elongated arms 14. In this way, the flexible member 12 can be securely adhered to the food container, while providing ease of removal for the user.

The line of perforation 16 extends along a width of each of the pair of elongated arms 14 and is configured to provide efficient tearing of the flexible member 12 therealong. The line of perforation 16 further operates as a point of failure for the flexible member 12, such that sufficient attempts at removing the flexible member 12 from the food container will cause the line of perforation 16 to tear, leaving visible evidence of potential tampering. When a user receives a food delivery, the user can easily inspect the line of perforation 16 for tears to determine whether any tampering was performed on the food container. Furthermore, when the user desires to remove the flexible member 12 from the food container, the line of perforation 16 can be torn, allowing the user to easily remove the elongated arm 14 from the food container, allowing the container to be opened. In embodiments where the adhesive is disposed between the distal end 25 and the line of perforation 16, the adhered section of the elongated arm 14 remains secured to the food container, while the remainder of the elongated arm 14 is removed therefrom.

In the illustrated embodiment, a second line of perforation 22 extends across a diameter of the central portion 13 parallel to the line of perforation 16. In this way, the user can easily remove the flexible member 12 from a food container by tearing along the second line of perforation 22. When secured to a food container, the flexible member 12 is placed such that the central portion 13 is disposed over an opening (shown in FIG. 3, 27) of the container, while the pair of elongated arms 14 secure to the container on opposing sides of the opening. A second line of perforation 22 as shown in the illustrated embodiment, allows a user to directly access the opening by tearing therealong. In embodiments where the adhesive is disposed along the entire lower surface 15 of the flexible member 12, the second line of perforation 22 allows a user to open the container without struggling to remove the adhesive from the container. In the shown embodiment, the central portion 13 further comprises a third line of perforation 24 thereacross, the third line of perforation 24 intersecting the second line of perforation 22 perpendicularly. In this way, the second and third lines of perforation 22, 24 provide independent axes of tearing, such that tampering with the flexible member 12 along various vectors of force results in tears in at least one line of perforation 16, 22, 24, thereby indicating to the user that an individual attempted to access the food container.

Referring now to FIG. 2, there is shown a perspective view of a protective cover of an embodiment of the anti-tamper band. In the illustrated embodiment, the flexible member 12 further comprises a protective cover 18 removably secured to the lower surface 15. The protective cover 18 is configured to preserve the adhesive until the user desires to removably secure the flexible member 12 to a food container. In some embodiments, multiple protective covers 18 are disposed along the lower surface 15, wherein the protective covers 18 are removably secured over sections of the lower surface 15 having adhesive thereon. In this way, in embodiments wherein the adhesive does not extend across the entire lower surface 15, the user can selectively determine which sections of adhesive to use to secure the flexible member 12 to a food container. Alternatively, in embodiments wherein the adhesive extends along the entire lower surface 15 of the flexible member 12, the protective cover 18 can comprise a plurality of sections, wherein each of the plurality of sections are separately removable from the lower surface, thereby allowing a user to selectively determine which sections of adhesive to use. In this way, costs of manufacturing various embodiments of flexible members 12 having different adhesive locations are minimized.

In the illustrated embodiment, the protective cover 18 further comprises a tab 19 extending therefrom, wherein the tab 19 extends beyond a perimeter of the flexible member 12. In this way, the tab 19 provides the user with a gripping surface, allowing easy removal of the protective cover 18 therefrom. In embodiments wherein the protective cover 18 comprises a plurality of sections, a tab 19 can extend from each of the plurality of sections, allowing a user to easily remove each section of protective cover 18 from the lower surface 15.

Referring now to FIG. 3, there is shown a perspective view of an embodiment of the anti-tamper band in use. In the illustrated embodiment, the flexible member 12 is removably secured to a food container 26 such that the central portion 13 is disposed over the opening 27 of the food container 26. This orientation allows quick access to the food container 26 via tearing along the second line of perforation 22. In the illustrated embodiment, the food container 26 comprises a folding foam container, however the flexible member 12 can be removably secured to various containers, including paper bags, Tupperware, pizza boxes, and the like. In one exemplary use, the user applies the flexible member 12 to a food container 26 such that each of the elongated arms 14 is secured on opposing sides of the opening 27. This allows the central portion 13 to be placed over the opening 27. In some embodiments, the user must first remove a protective cover from the lower surface of the flexible member 12, before applying the flexible member 12 to the food container 26. The time of packaging can then be recorded on the flexible member 12 as indicated by the indicia 21, such that the user can determine how long the food container 26 was in transit. Upon receipt of the food container 26, the user can then inspect the line of perforation 16 and the second line of perforation 22 for tears indicating a possible attempt to tamper with the food within the food container 26. Alternatively, the user can inspect the food container 26 for damage caused in removing the adhered portions of the flexible member 12 from the food container 26. Once the user is satisfied that no tampering took place, the user can tear along the line of perforation 16 or the second line of perforation 22 to remove the flexible member 12 and open the food container 26.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. An anti-tamper band, comprising:
a flexible member having a central portion and a pair of elongated arms;
wherein the pair of elongated arms extend from opposing ends of the central portion;
an adhesive disposed along a lower surface of the flexible member; and
a line of perforation disposed across a width of each of the pair of elongated arms.

2. The anti-tamper band of claim 1, wherein the central member comprises a circular shape having a diameter greater than the width of the pair of elongated arms.

3. The anti-tamper band of claim 1, further comprising a protective cover removably secured to the lower surface, the protective cover configured to preserve the adhesive properties of the adhesive.

4. The anti-tamper band of claim 3, wherein the protective cover further comprises a tab extending therefrom, the tab extending beyond a perimeter of the flexible member.

5. The anti-tamper band of claim 1, further comprising indicia disposed on an upper surface of the flexible member, wherein the indicia is configured to indicate the time of application of the flexible member.

6. The anti-tamper band of claim 1, wherein the adhesive is configured to permanently affix to a container.

7. The anti-tamper band of claim 1, wherein a second line of perforation extends across a diameter of the central portion.

8. The anti-tamper band of claim 7, wherein the second line of perforation is parallel to each line of perforation.

9. The anti-tamper band of claim 7, wherein a third line of perforation extends across the central portion and intersects the second line of perforation perpendicularly.

10. The anti-tamper band of claim 1, wherein the adhesive is disposed along the lower surface between each line of perforation and a distal end of each of the pair of elongated arms.

11. The anti-tamper band of claim 10, wherein the adhesive is disposed along the lower surface of the central portion.

12. A method of using an anti-tamper band, comprising:
applying a flexible member having a central portion and a pair of elongated arms extending therefrom to a container, wherein a lower surface of the flexible member comprises an adhesive thereon;
wherein each of the elongated arms are disposed on the container on opposing sides of an opening of the container;
inspecting a line of perforation extending along a width of each of the pair of elongated arms for damage;
tearing along the line of perforation to remove the flexible member from the container; and
opening the container.

13. The method of using the anti-tamper band of claim 12, further comprising removing a protective cover extending along a lower surface of the flexible member.

14. The method of using the anti-tamper band of claim 12, further comprising recording a time of application on an upper surface of the flexible member as indicated by an indicia thereon.

15. The method of using the anti-tamper band of claim 12, further comprising inspecting the container for damage caused by removal of the adhesive.

16. An anti-tamper band, consisting of:
a flexible member having a central portion and a pair of elongated arms;
wherein the pair of elongated arms extend from opposing ends of the central portion;
an adhesive disposed along a lower surface of the flexible member;
a line of perforation disposed across a width of each of the pair of elongated arms;
a second line of perforation extending across a diameter of the central portion;
wherein the second line of perforation is parallel to each line of perforation; and
a third line of perforation extending across the central portion and intersecting the second line of perforation perpendicularly.
